(19) United States
(12) Patent Application Publication
(10) Pub. No.: US 2026/0095981 A1
(43) Pub. Date: Apr. 2, 2026

(54) SUSCEPTOR HEATER

(71) Applicant: ASM IP Holding B.V., Almere (NL)

(72) Inventor: Koei Aida, Tokyo (JP)

(21) Appl. No.: 19/339,497

(22) Filed: Sep. 25, 2025

Related U.S. Application Data
(60) Provisional application No. 63/700,943, filed on Sep. 30, 2024.

(51) Int. Cl. H05B 6/10; H05B 6/36

(52) U.S. Cl. CPC H05B 6/105; H05B 6/36

(57) ABSTRACT

A susceptor heater is presented. To avoid exposing different materials of the susceptor to the plasma environment, the present disclosure presents a susceptor heater comprises a susceptor part comprising: an upper part; a lower part; and a plurality of heating elements disposed between the upper part and the lower part; and a shaft part, wherein the upper part and the lower part are bonded with diffusion bonding. In another embodiment, the present disclosure also presents a susceptor heater, comprises: a susceptor part comprising: an upper part dented upward in the center; a lower part shaped to be fitted into the dented area of the upper part; and a plurality of heating elements disposed on the lower part between the upper part and the lower part; and a shaft part, wherein the upper part and the lower part are bonded horizontally with brazing and bonded vertically with electrical beam welding.

### CROSS-REFERENCE TO RELATED APPLICATIONS

This application claims priority to U.S. Provisional Patent Application Ser. No. 63/700,943 filed Sep. 30, 2024 titled SUSCEPTOR HEATER, the disclosure of which is hereby incorporated by reference in its entirety.

### FIELD OF INVENTION

The present disclosure relates generally to a susceptor heater used in semiconductor processing, more particularly to a susceptor heater with no brazing part exposed on its surface.

### BACKGROUND OF THE DISCLOSURE

When manufacturing a metal susceptor heater, it is common to sandwich heater wires between two pieces of metal and braze them. In addition, to increase corrosion resistance, the material is anodized after brazing.

However, the properties of the anodized film on the surface of the brazing are different from those of the other parts. This is because, in the case of brazing, the material of the metal to be joined and the material of the brazing are different just shown in FIG. 1

In the PECVD (Plasma Enhanced Chemical Vapor Deposition) and PEALD (Plasma Enhanced Atomic Layer Deposition) process, the plasma becomes unstable only around the brazing area (A, B) during film formation, causing problems such as particles generation, abnormal plasma behavior, and poor film uniformity.

Therefore, the present disclosure provides a susceptor heater structure so that the brazing area may not be exposed to the surface.

### SUMMARY OF THE DISCLOSURE

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

In accordance with one embodiment there may be provided, a susceptor heater, comprises: a susceptor part comprising: an upper part; a lower part; and a plurality of heating elements disposed between the upper part and the lower part; and a shaft part, wherein the upper part and the lower part are bonded with diffusion bonding.

In an aspect, the susceptor heater further comprising an anodized film layer configured to coat an outer surface of the susceptor part and the shaft part.

In accordance with another embodiment there may be provided, a susceptor heater, comprises: a susceptor part comprising: an upper part dented upward in the center; a lower part shaped to be fitted into the dented area of the upper part; and a plurality of heating elements disposed on the lower part between the upper part and the lower part; and a shaft part, wherein the upper part and the lower part are bonded horizontally with brazing and bonded vertically with electrical beam welding.

In an aspect, the susceptor heater further comprising an anodized film layer configured to coat an outer surface of the susceptor part and the shaft part.

In accordance with another embodiment there may be provided, a susceptor heater, comprises: a susceptor part comprising: an upper part shaped to be bulging in a center; a lower part shaped to be hollow in a center; and a plurality of heating elements disposed on the lower part between the upper part and the lower part; and a shaft part, wherein the upper part and the lower part are bonded with brazing in the center and bonded in an outer rim with electrical beam welding.

In an aspect, the susceptor heater further comprising an anodized film layer configured to coat an outer surface of the susceptor part and the shaft part.

### BRIEF DESCRIPTION OF THE DRAWING FIGURES

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

FIG. 1 illustrates a prior art of a susceptor heater.

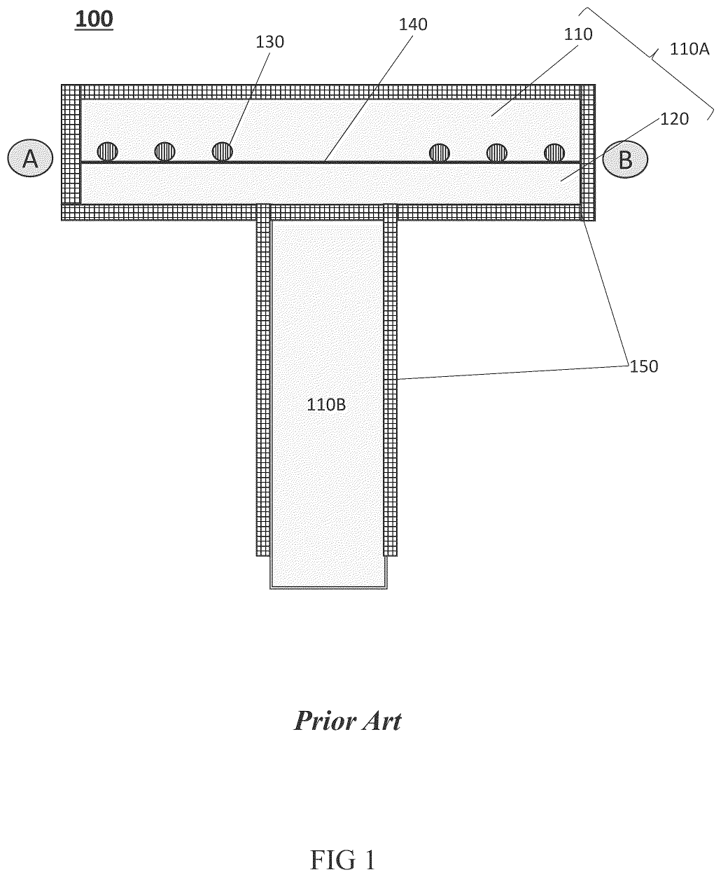

FIG. 2 illustrates an embodiment of a susceptor heater according to the present disclosure.

FIG. 3 illustrates another embodiment of a susceptor heater according to the present disclosure.

FIG. 4 illustrates another embodiment of a susceptor heater according to the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Substrates may be made from semiconductor materials, including, for example, silicon, silicon germanium, silicon oxide, gallium arsenide, gallium nitride and silicon carbide.

As examples, a substrate in the form of a powder may have applications for pharmaceutical manufacturing. A porous substrate may comprise polymers. Examples of workpieces may include medical devices (for example, stents and syringes), jewelry, tooling devices, components for battery manufacturing (for example, anodes, cathodes, or separators) or components of photovoltaic cells, etc.

A continuous substrate may extend beyond the bounds of a process chamber where a deposition process occurs. In some processes, the continuous substrate may move through the process chamber such that the process continues until the end of the substrate is reached. A continuous substrate may be supplied from a continuous substrate feeding system to allow for manufacture and output of the continuous substrate in any appropriate form.

Non-limiting examples of a continuous substrate may include a sheet, a non-woven film, a roll, a foil, a web, a flexible material, a bundle of continuous filaments or fibers (for example, ceramic fibers or polymer fibers). Continuous substrates may also comprise carriers or sheets upon which non-continuous substrates are mounted.

The illustrations presented herein are not meant to be actual views of any particular material, structure, or device, but are merely idealized representations that are used to describe embodiments of the disclosure.

The particular implementations shown and described are illustrative of the invention and its best mode and are not intended to otherwise limit the scope of the aspects and implementations in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationship or physical connections may be present in the practical system, and/or may be absent in some embodiments.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The subject matter of the present disclosure includes all novel and nonobvious combinations and subcombinations of the various processes, systems, and configurations, and other features, functions, acts, and/or properties disclosed herein, as well as any and all equivalents thereof.

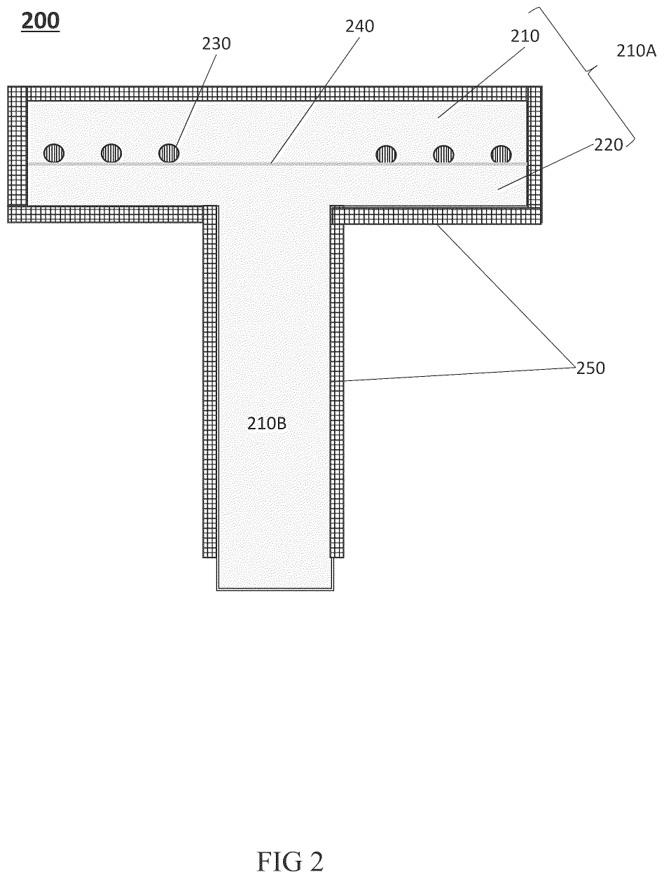

FIG. 2 illustrates an embodiment of a susceptor heater according to the present disclosure.

A susceptor heater 200 may comprise a susceptor part 210A, and a shaft part 210B. The susceptor part 210A may comprise an upper part 210 and a lower part 220. The susceptor heater 200 may also comprise heating elements 230 placed between the upper part 210 and the lower part 220. The shaft part 210B may be placed below the susceptor part 210A.

In this embodiment, the upper part 210 and the lower part 220 may be bonded with diffusion bonding. The diffusion bonding does not use any foreign materials, such as those used in brazing. The material of the bonded portion is the same as that of parts 210 and 220.

After the diffusion bonding, an anodized film layer may be coated all around the outer surface of the susceptor part 210A and the shaft part 210B.

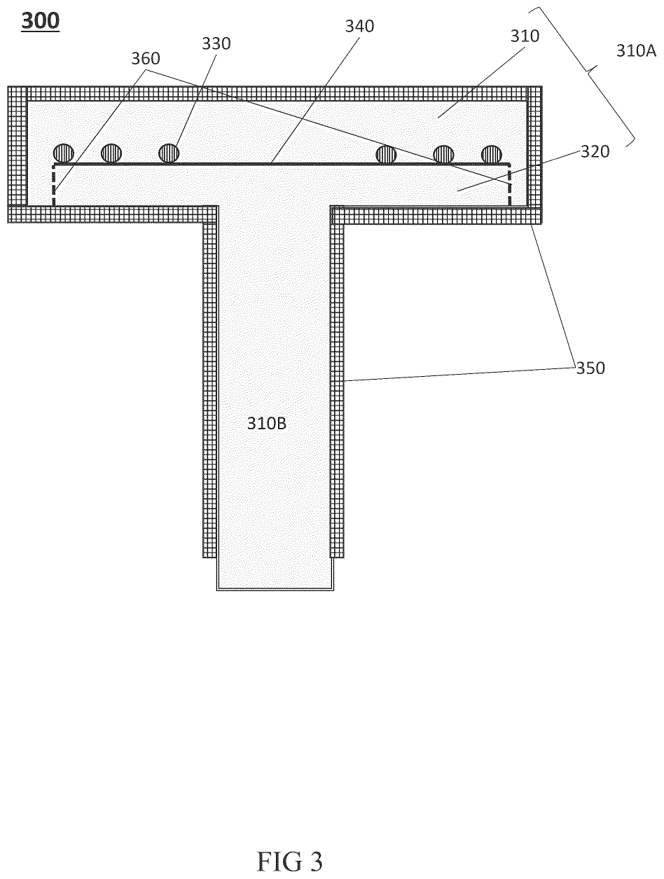

FIG. 3 illustrates another embodiment of a susceptor heater according to the present disclosure.

A susceptor heater 300 may comprise a susceptor part 310A, and a shaft part 310B. The susceptor part 310A may comprise an upper part 310 and a lower part 320. The susceptor heater 300 may also comprise heating elements 330 placed on the lower part 320 and between the upper part 310 and the lower part 320. The shaft part 310B may be placed below the susceptor part 310A.

The shape of the upper part 310 may be shaped like a cylinder with a hollow (or dent) in the center area of its bottom side and the lower part 320 may be shaped so that it may be perfectly fitted into the hollow area of the upper part 310.

In this embodiment, the upper part 310 and the lower part 320 may be bonded with brazing horizontally 340 and electrical beam welding vertically 360. The area that brazing is used remains only inside of the susceptor 300 and only the electrical beam welding may be exposed to its surface.

After the brazing and electrical beam welding, an anodized film layer may be coated all around the outer surface of the susceptor part 310A and the shaft part 310B.

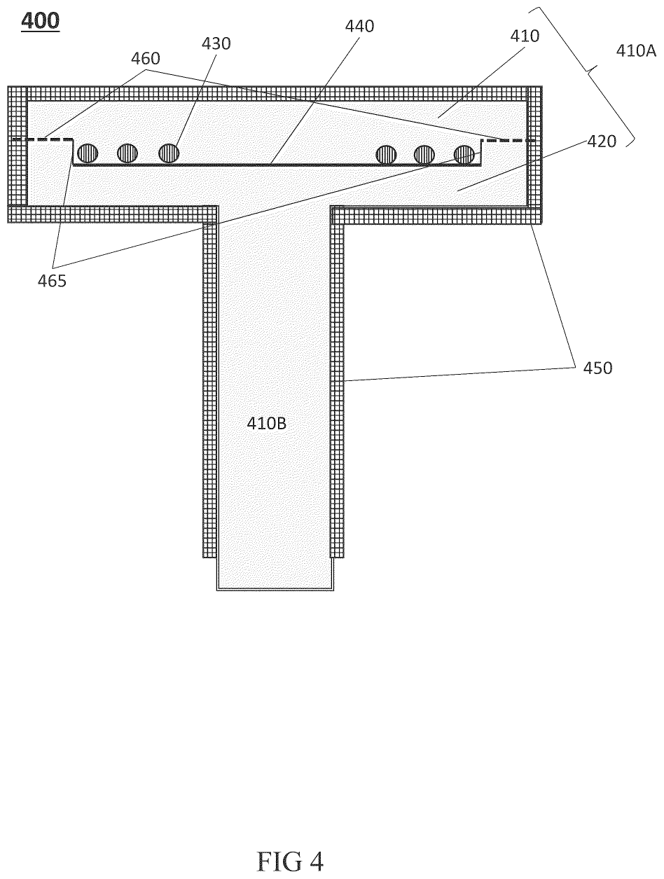

FIG. 4 illustrates another embodiment of a susceptor heater according to the present disclosure and this is a different shape of the upper part 410A and the lower part 410B.

A susceptor heater 400 may comprise a susceptor part 410A, and a shaft part 410B. The susceptor part 410A may comprise an upper part 410 and a lower part 420. The susceptor heater 400 may also comprise heating elements 430 placed on the lower part 420 and between the upper part 410 and the lower part 420. The shaft part 410B may be placed below the susceptor part 410A.

The shape of the upper part 410 may be shaped like a cylinder with a bulge in the center area of its bottom side and the lower part 420 may be shaped like a cylinder with a hollow in the center area of its top side so that the bulge of the upper part 410 may be perfectly fitted into the hollow area of the lower part 420.

In this embodiment, the upper part 410 and the lower part 420 may be bonded with brazing horizontally 440 in the center area and electrical beam welding 460 in around the outer rim as illustrated in FIG. 4. The vertical contact 465 between the upper part 410 and the lower part 420 may not be subjected to any processing. The area that brazing is used remains only inside of the susceptor 400 and only the electrical beam welded area 460 may be exposed to its surface.

After the brazing and electrical beam welding, an anodized film layer may be coated all around the outer surface of the susceptor part 410A and the shaft part 410B.

There may be other shapes of the upper part and the lower part of the susceptor and in the other shapes, the brazing is not exposed to the surface either.

The above-described arrangements of apparatus are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

1. A susceptor heater, comprises:
a susceptor part comprising:
an upper part;
a lower part; and
a plurality of heating elements disposed between the upper part and the lower part; and
a shaft part, wherein the upper part and the lower part are bonded with diffusion bonding.

2. The susceptor heater according to claim 1, further comprising
an anodized film layer configured to coat an outer surface of the susceptor part and the shaft part.

3. A susceptor heater, comprises:
a susceptor part comprising:
an upper part dented upward in the center;
a lower part shaped to be fitted into the dented area of the upper part; and
a plurality of heating elements disposed on the lower part between the upper part and the lower part; and
a shaft part, wherein the upper part and the lower part are bonded horizontally with brazing and bonded vertically with electrical beam welding.

4. The susceptor heater according to claim 3, further comprising
an anodized film layer configured to coat an outer surface of the susceptor part and the shaft part.

5. A susceptor heater, comprises:
a susceptor part comprising:
an upper part shaped to be bulging in a center;
a lower part shaped to be hollow in a center; and
a plurality of heating elements disposed on the lower part between the upper part and the lower part; and
a shaft part, wherein the upper part and the lower part are bonded with brazing in the center and bonded in an outer rim with electrical beam welding.

6. The susceptor heater according to claim 5, further comprising
an anodized film layer configured to coat an outer surface of the susceptor part and the shaft part.
